(19) United States
(12) Patent Application Publication
(10) Pub. No.: US 2009/0276298 A1
(43) Pub. Date: Nov. 5, 2009

(54) Community virtual network operator

(75) Inventor: Wei Kang Tsai, Irvine, CA (US)

Correspondence Address: Wei Kang Tsai, 8 Young Court, Irvine, CA, 92617, US

(73) Assignee: Grasstell Networks LLC

(21) Appl. No.: 12/387,191

(22) Filed: Apr. 29, 2009

Related U.S. Application Data
(60) Provisional application No. 61/125,816, filed on Apr. 29, 2008.

(51) Int. Cl. G06Q 99/00; G06Q 30/00; G06Q 50/00

(52) U.S. Cl. 705/14.1; 705/14.45; 705/1

(57) ABSTRACT

A virtual network operator without leasing bandwidths is built with subscribers paying their bandwidths, using installed customer premise equipments as the main part of its infrastructure. These CPEs work together in a P2P manner so that self-sustaining services can be offered without an operator, with only collaborating subscribers forming a community. While the subscriber pays an amount approximating (either above or below) the cost of the installed CPE associated with the operator, the operator provides a plurality and a range of free and fee-based services either directly or through a third party vendor. A preferred CPE is a personal infotainment center device that enables personalized multimedia services such as video conferencing and a plurality of multimedia functions and services. The operator receives revenues from targeted and non-targeted advertisement, e-commerce of all sorts, and the provision of content.

### CROSS REFERENCE TO RELATED APPLICATION

This application claims the benefit of U.S. Provisional Patent Application Ser. No. 61/125,816, filed Apr. 29, 2008, the disclosure of which is herein expressly incorporated by reference.

### FIELD OF THE INVENTION

The present invention relates in general, to telecommunication service providers and consumer electronics, and more particularly, to virtual service providers with emphasis on multimedia communications and consumer electronics enabled services.

### BACKGROUND OF THE INVENTION

The main barrier to entry for service provider business is the high-cost infrastructure needed to provision services. For simplicity, the words provider and operator are used interchangeably hereafter.

It is important to delineate infrastructure components carefully. First, there is a difference between network infrastructure and customer premise equipment (CPE).

Second, within network infrastructure, there is a distinction between bandwidth and service infrastructures. Bandwidth infrastructure is built to provision bandwidths; while service infrastructure is built to provision services. Examples of service infrastructure include server and data infrastructures for content serving, data storage, directory lookup, connection setup, and billing.

Today, bandwidths are provided by Internet service providers (ISPs) and network service providers (NSPs). Services are provided by application service providers (ASPs). However, this division is not ideal. A reason is that telecommunications companies often employ bundled services to retain customers. It is common for a bandwidth provider to offer services such as voice, and video (IPTV and cable TV).

An implication from the present invention is that customers will find it desirable to separate bandwidth and service providers.

Service providers can be categorized by infrastructure ownership. A bandwidth provider is often called a facility-based provider, while a non-facility based provider is often called a virtual operator. This classification is quite confusing as every virtual operator also owns some facilities.

Examples of facility-based service providers include the usual telecommunications and cable companies. Facility-based providers usually limit their services to geographically defined subscribers. For example, a cable company usually does not offer services to a subscriber without a physical cable connection to its access network.

Many non-facility based virtual operators do own extensive service infrastructures. For example, a mobile virtual network operator (MVNO) may own home location registers, business support systems, or mobile virtual network enablers. All MVNOs lease bandwidths leased from mobile network operators. Other non-facility operators such as ISPs lease bandwidths and operate their own data centers. Most virtual operators are still geographically focused. These operators will be called bandwidth-leasing virtual providers.

Other virtual operators don't lease bandwidths; they obtain bandwidths indirectly through their subscribers. These virtual providers enter into contracts with subscribers to allow them to use bandwidths leased by their subscribers; such virtual providers will be referred to as bandwidth-less virtual providers. Skype, VoIPBuster, and other PC-based VoIP (voice over IP) virtual providers belong to this group. Such operators are said to be software-enabled as they rely on software inserted into subscriber devices. Most bandwidth-less virtual operators are not geographically focused.

The present invention creates a class of operators called community virtual network operators (CVNOs). A CVNO is a bandwidth-less virtual operator in the spirit of social community business. A CVNO is also different from software-enabled virtual operators such as Skype in that it is enabled by hardware CPEs as the main part of its infrastructure.

For facility-based providers, CPEs are either owned by a provider or their subscribers. Often, a CPE is given to a subscriber free as a subsidy. On the other hand, for bandwidth-less providers, CPEs are often purchased by subscribers and contracts between the provider and subscribers allow the provider to use them for free.

For a CVNO, CPE plays the dual role of communications and consumer electronic equipment. A subscriber would pay a membership fee and receive a CPE which remains as an integral part of the operator's network. A CVNO is allowed to utilize the network of installed CPEs to provide services.

Today, facility-based providers have enjoyed high profit margins and steady incomes compared to non-facility based providers and equipment makers. A main reason is that they own infrastructures that are prohibitively expensive. This makes many facility-based providers de facto local monopolies. Therefore, these providers are reaping supernormal profits (above normal economic profits).

It is an object of the present invention to reduce drastically the above normal economic profits of facility-based operators by going directly to end users. The new operators (CVNOs) rely on subscribers paying for bandwidths, and a new CPE called personal infotainment center (PIC).

A PIC is a piece of CPE, connectable to an IP network through either fixed or mobile channels. A variant of PIC can be plugged into a socket inside a vehicle. The entirety of PICs installed at subscriber premises will function as the main part of the infrastructure for a CVNO. In addition, non-PIC devices can be added to enhance the infrastructure. As there are no expensive carrier-grade gears owned or operated by a CVNO, capital and operating expenditures are drastically reduced.

A PIC is a consumer-friendly special-purpose appliance with a display screen that provides a plurality of multimedia contents. Thus, PICs are an alternative to TV sets and personal computers. PICs are non-intrusive in the sense that they do not impose attention even when they are powered on.

With different adaptations, a PIC can work as a video phone, game player, Web browser, or download device for a plurality of multimedia contents. CPEs (PICs in particular) enable a CVNO to offer free and fee-based value-added. With free services and incentives, a CVNO could use network marketing to expand its subscriber base.

While PIC is the preferred CPE, it is not the only choice. The main benefits of using PICs are that they enable a CVNO to receive a constant stream of income based on value-added services.

In accordance with one aspect of the present invention, while a subscriber pays an amount to become a subscriber, a CVNO retains the right to use the CPE to benefit itself. The payment may be construed either as membership or leasing fees, but not as the payment for the CPE. A CVNO can choose not to sell the CPE, but only to sell services.

### BRIEF SUMMARY OF THE INVENTION

It is, therefore, an object of the present invention to provide a system of methods to operate a CVNO with subscribers paying bandwidths and other fees, while the CVNO retains the right to use the installed CPEs, which is the main part of its service infrastructure.

A CVNO is to provide their subscribers with a plurality of value-added services with fees or no fees. These services include, while not restricted to, video phone services, voice phone services, picture frame, content download, Internet radio, media player, e-commerce, home shopping TV, Internet and IPTV, news services, and event trigger services. Often a CVNO will insert targeted or non-targeted advertisements and observe customer behaviors through the CPEs installed at subscriber premises. Third party software is also allowed on the CPEs to enable a CVNO to collect revenues through third party vendors.

A CVNO can operate in an operator-less mode in that a plurality of self-sustaining free services operate without any interventions from the CVNO. Therefore, even if the CVNO ceases its operations, these self-sustaining free services can continue through collaborating subscribers. This is a good reason for a CVNO to be called a community company.

Network marketing and viral growth marketing techniques such as multi-level marketing and incentives programs are often deployed by a CVNO.

The preferred CPE installed at a subscriber's premise is called a PIC, which is an always-on consumer electronic appliance with input-output (I/O) devices such as visual display screens, touch screens, pointing devices, audio/video I/O devices, key pads, soft keys, buttons, and USB ports.

A PIC is also an IP device that can connect to an IP network through a fixed or wireless channel.

### BRIEF DESCRIPTION OF THE DRAWINGS

The above and other objects and features in accordance with the present invention will become apparent from the following descriptions of embodiments in conjunction with the accompanying drawings, and in which:

FIG. 1 shows a CVNO with a heterogeneous mix of CPEs;

FIG. 2 illustrates a CVNO with PICs as the main CPEs.

### DETAILED DESCRIPTION OF EXEMPLARY EMBODIMENTS

The present invention can be described in two parts: CVNO and PIC.

In accordance with one aspect of present invention, a CVNO owns its service infrastructure partly through a contract with their subscribers. A subscriber pays an amount which may approximate the cost of the CPE installed at the subscriber's premise, while the operator retains the right to use and to modify the CPE. A subscriber may pay a membership fee to receive services provided by the virtual operator. The entirety of the CPE installed at subscriber premises form the major part of the operator's infrastructure.

Free and fee-based services from a CVNO can be chosen from, while not restricted to, telephone services, video phone services, news and infotainment services, Internet radio, content download, e-commerce, home-shopping, phone directory services (white and yellow page), picture frame, and event trigger services.

Free services from a CVNO may be restricted in different ways. In one embodiment, free voice or video phone calls may be restricted to connections between subscribers initially. At a later stage, subscribers are allowed to call non-subscribers for free depending on availability of resources in the operator's network. Free upgrades in the services offered by a CVNO are provided over time in a progressive manner. For example, free long distance phone services are gradually increased in coverage and features.

According to an embodiment of the present invention, the service infrastructure of a CVNO is enabled by DHT (distributed hash table) or a functionally equivalent algorithm for distributed lookup. With this type of algorithms, the service infrastructure is decentralized, and may be implemented without servers, dramatically reducing capital and operating expenditures.

In particular, a subscriber of a CVNO allows the operator to insert targeted or non-targeted advertisements in the CPEs, obtained through or allowed by the operator. The subscriber may also allow the operator to observe user behaviors in the services offered through the CVNO. Granting a CVNO the right for user profiling may be a requirement to obtain the CVNO services.

According to an embodiment of the present invention, the CVNO deploys network marketing channels such as Amway, to market the operator's CPE and services. In another embodiment, the operator deploys other forms of network marketing by incentive programs to help recruit new subscribers. Incentives such as profit sharing can be used to encourage a subscriber to help market for a CVNO. One form of incentive is reward of shares in the CVNO company.

According to one aspect of the present invention, self-sustaining free services enabled by a CVNO can continue without the CVNO being in existence. These services are realized by the network of CPEs from collaborating subscribers without any interventions from the CVNO. These services operate in a pure form of P2P (peer-to-peer), wherein each subscriber's CPE works as a peer device.

In accordance with one aspect of the present invention, a PIC is the preferred CPE and is designed to be placed into different environments such as living rooms, bedrooms, kitchens, bathrooms, offices, laboratories, and outdoor environments. In other variations, a PIC allows personalized settings for its features and functionalities. Most PICs are portable and light-weighted—suitable for travel use.

A PIC is equipped to perform functions required to deliver services such as, while not restricted to, phone services, video phone services, photo album, targeted and non-targeted advertising, home shopping, e-commerce, content download, infotainment services, Internet radio, and event trigger services.

A PIC is also equipped with input-output devices such as display screens, touch screens, pointing devices, audio/video I/O input devices, key pads, soft keys, buttons, and USB ports.

According to another embodiment, a PIC is also equipped with the wireless router functionalities such as those present in a Wi-Fi router, wireless base station, or wireless mesh access point. In this case, a subscriber may access the Internet from other access points outside the subscriber's premise.

According to another embodiment, the PIC software platform is open to third party developers to enable third party applications to be inserted into PIC devices.

A variant of PIC functions as a picture frame while it in a standby or inactive mode. In addition, a PIC in a standby or inactive mode may also function also as a voice telephone, video telephone set, a media player, a picture frame, or an alarm clock.

In one embodiment, a PIC will show a marketing piece, when a user starts to make a voice or video phone call by dialing. Yet in another embodiment, when a user starts to use a free service offered from a PIC network operator, an advertisement piece is shown before a service is fully engaged.

In one embodiment, a PIC also serves as a docking station for portable devices such as cellular phones, VoIP phones, mobile TV devices, and other handheld devices. The docking station also charges the battery of the handheld device if the PIC is connected with a power source.

In one embodiment, a PIC also serves as a surveillance camera whereby live videos can be streamed to specified destination devices.

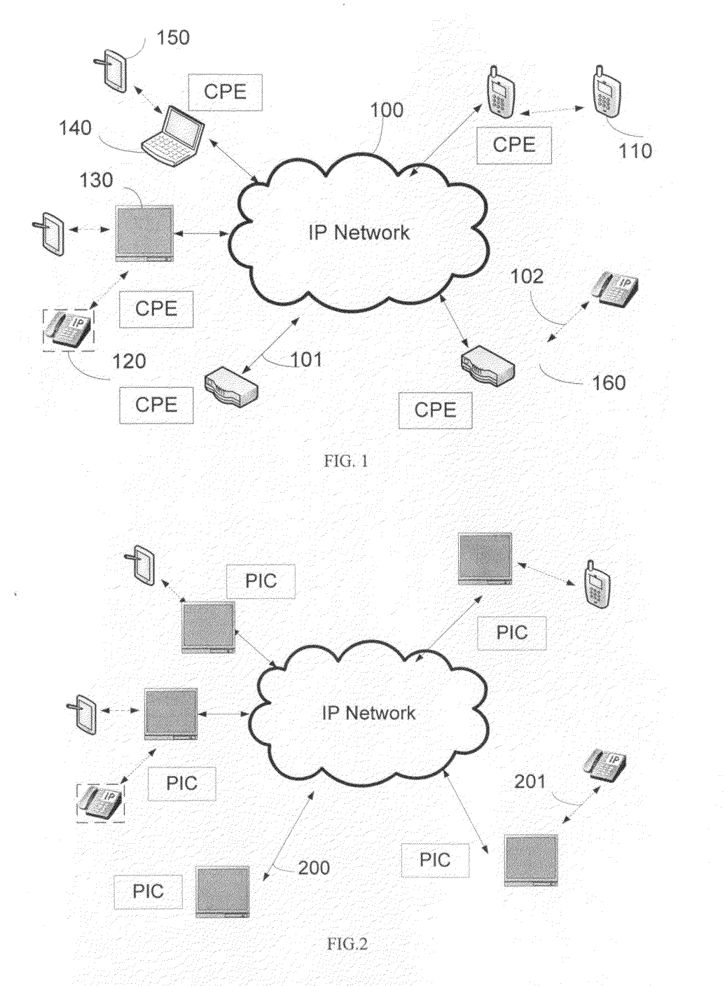

FIG. 1 illustrates a CVNO with a heterogeneous set of CPEs. In this configuration, a CPE can be an IP phone 120, a cell phone 110, a smart phone or PDA 150, a laptop PC 140, a PIC 130, and a Wi-Fi router 160. All these devices are connected through a big IP network, which could be the Internet 100. There are two kinds of IP connections: connection 101 to the big IP network and connection 102 in local networks.

FIG. 2 illustrates a CVNO with a homogeneous set of CPEs (in this case PICs). Again, there are two kinds of IP connections: connection 200 to the big network and connection 201 in a local area network. Notice that while PICs serve as the gateway to the bi IP networks, other CPEs (such as cell phones, IP phones, etc.) are connected in a local network through the PICs.

In one embodiment, a PIC network is hosted in a hospital and serves as the patient infotainment equipment or service ordering equipment. One such embodiment will allow a patient to choose between among IPTV programs, Internet radio programs, e-books, Web surfing, and others for the patient's infotainment needs. The same equipment also allows a patient to request patient care from the hospital.

In another embodiment, a PIC network is installed in a hotel whereby guests utilize services offered by a PIC network to access hotel guest services.

In yet another embodiment, a PIC network is used to provide community services for a private or public community. In one such embodiment, a church uses a PIC network to announce church activities and news to members of the church. Another example is a residential community using a PIC network for community announcements.

In other embodiments, a PIC network is used to host corporation related services. In one such embodiment, a PIC on an employee desktop is used for video conferencing, corporate announcements, lunch ordering, and other corporate functions.

What is claimed is:

1. A system to realize a community virtual network operator (CVNO) with self-sustaining free services without bandwidth leasing, comprising:
a plurality of subscribers;
at each said subscriber's premise, a CPE is installed;
a contract to allow said CVNO and a third party to use and modify said CPEs;
a DHT (distributed hash table) based algorithm for directory lookup;
wherein each said subscriber pays for his own bandwidths, and pays a fee for a plurality of services offered through said CVNO; each said CPE is an IP device; said installed CPEs form an overlay in P2P architecture.

2. The system of claim 1, wherein each said CPE is a fixed or mobile IP device which can be a computer, a phone device, a personal digital assistant, a gaming device, a switch, a router, a media player, a consumer electronic appliance, or a special-purpose hardware device.

3. The system of claim 2, wherein a plurality of value-added services with fees or without fees, are offered either directly through said CVNO or through a third party vendor; said services include, while not restricted to telephone services, video phone services, news services, news and infotainment services, Internet radio, content download, e-commerce, home-shopping, phone directory services (white and yellow page), picture frame, and event trigger services.

4. The system of claim 3, wherein said CVNO or a third party vendor is allowed to insert targeted and non-targeted advertisements into said installed CPEs, and to observe collect data on user behaviors on the services through said CVNO on said installed CPEs.

5. The system of claim 4, wherein said CVNO sets up free services for said subscribers such that these services are completely self-sustaining without any interventions from said CVNO; such services operate solely in a P2P manner.

6. The system of claim 4, wherein said CVNO deploys viral growth and network-marketing methods to increase its customer base by offering shares in said CVNO company and other incentives to reward subscribers through whom subscribers or sales are increased.

7. The system of claim 5, adapted to realize a infotainment service network for a hospital or a hotel, wherein
a said CPE is used to order hotel guess services in a hotel;
a said CPE is used to order patient care services in a hospital;
a said CPE is used to provide infotainment for patients in a hospital or guesses in a hotel.

8. The system of claim 5, adapted to realize infotainment services for a public or private community, wherein
a said CPE is used to make announcements for a said community;
a said CPE is used to for communications between and among community members;

9. The system of claim 5, adapted to realize infotainment services for a corporation or an organization, wherein
a said CPE is used to make announcements for a corporation or organization;
a said CPE is used for conferencing, e-commerce, and communications between and among workers for a corporation or organization;

10. A CPE adapted for CVNO operations called PIC (personal infotainment center), wherein each said PIC
is equipped with input-output devices such as display screens, touch screens, pointing devices, audio/video I/O input devices, key pads, soft keys, buttons, or USB ports;
is equipped as an option with wireless router functionalities such as those present in a Wi-Fi router, wireless base station, or wireless mesh access point;
is designed as an option to also function as a surveillance camera capable of streaming video;
is designed as an option to allow third party software;
is designed as an option to allow field upgrade capability;
is designed as an option to function in a standby or inactive mode as a picture frame, a voice telephone, video telephone set, a media player, a picture frame, an alarm clock, a docking station, or a combination thereof.

11. A computer-readable medium with a computer program for performing the methods as described in any one of claims 1 to 10.
